(19) United States
(12) Patent Application Publication
(10) Pub. No.: US 2012/0169583 A1
(43) Pub. Date: Jul. 5, 2012

(54) SCENE PROFILES FOR NON-TACTILE USER INTERFACES

(75) Inventors: Eran Rippel, Herzliya (IL); Erez Sali, Savyon (IL); Yael Shor, Tel-Aviv (IL); Einat Kinamon, Tel-Aviv (IL); Tomer Yanir, Yehud-Monosson (IL)

(73) Assignee: PRIMESENSE LTD., Tel Aviv (IL)

(21) Appl. No.: 13/295,106

(22) Filed: Nov. 14, 2011

Related U.S. Application Data
(60) Provisional application No. 61/429,767, filed on Jan. 5, 2011.

(51) Int. Cl. G09G 5/00

(52) U.S. Cl. 345/156

(57) ABSTRACT

A method, including capturing an image of a scene including one or more users in proximity to a display coupled to a computer executing a non-tactile interface, and processing the image to generate a profile of the one or more users. Content is then selected for presentation on the display responsively to the profile.

### RELATED APPLICATION

This application claims the benefit of U.S. Provisional Patent Application 61/429,767, filed on Jan. 5, 2011, which is incorporated herein by reference.

### FIELD OF THE INVENTION

This invention relates generally to user interfaces for computerized systems, and specifically to user interfaces that are based on non-tactile sensing.

### BACKGROUND OF THE INVENTION

Many different types of user interface devices and methods are currently available. Common tactile interface devices include a computer keyboard, a mouse and a joystick. Touch screens detect the presence and location of a touch by a finger or other object within the display area. Infrared remote controls are widely used, and “wearable” hardware devices have been developed, as well, for purposes of remote control.

Computer interfaces based on three-dimensional (3D) sensing of parts of a user's body have also been proposed. For example, PCT International Publication WO 03/071410, whose disclosure is incorporated herein by reference, describes a gesture recognition system using depth-perceptive sensors. A 3D sensor, typically positioned in a room in proximity to the user, provides position information, which is used to identify gestures created by a body part of interest. The gestures are recognized based on the shape of the body part and its position and orientation over an interval. The gesture is classified for determining an input into a related electronic device.

Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

As another example, U.S. Pat. No. 7,348,963, whose disclosure is incorporated herein by reference, describes an interactive video display system, in which a display screen displays a visual image, and a camera captures 3D information regarding an object in an interactive area located in front of the display screen. A computer system directs the display screen to change the visual image in response to changes in the object.

### SUMMARY OF THE INVENTION

There is provided, in accordance with an embodiment of the present invention a method, including capturing an image of a scene including one or more users in proximity to a display coupled to a computer executing a non-tactile interface, processing the image to generate a profile of the one or more users, and selecting content for presentation on the display responsively to the profile.

There is also provided, in accordance with an embodiment of the present invention an apparatus, including a display, and a computer executing a non-tactile interface and configured to capture an image of a scene including one or more users in proximity to the display, to process the image to generate a profile of the one or more users, and to select content for presentation on the display responsively to the profile.

There is further provided, in accordance with an embodiment of the present invention a computer software product including a non-transitory computer-readable medium, in which program instructions are stored, which instructions, when read by a computer executing a non-tactile three dimensional user interface, cause the computer to capture an image of a scene comprising one or more users in proximity to the display, to process the image to generate a profile of the one or more users, and to select content for presentation on the display responsively to the profile.

### BRIEF DESCRIPTION OF THE DRAWINGS

The disclosure is herein described, by way of example only, with reference to the accompanying drawings, wherein:

FIG. 1 is a schematic pictorial illustration of a computer implementing a non-tactile three dimensional (3D) user interface, in accordance with an embodiment of the present invention;

FIG. 2 is a flow diagram that schematically illustrates a method of defining and updating a scene profile, in accordance with an embodiment of the present invention; and

FIG. 3 is a schematic pictorial illustration of a scene comprising a group of people in proximity to a display controlled by the non-tactile 3D user interface, in accordance with an embodiment of the present invention.

### DETAILED DESCRIPTION OF EMBODIMENTS

### Overview

Content delivery systems (such as computers and televisions) implementing non-tactile user interfaces can be used by different groups of one or more people, where each of the groups may have different content preferences. For example, a group of children may prefer to watch cartoons, teenagers may prefer to execute social web applications, and adults may prefer to watch news or sports broadcasts.

Embodiments of the present invention provide methods and systems for defining and maintaining a profile (also referred to herein as a scene profile) that can be used to select content for presentation on a content delivery system. The profile can be based on identified objects and characteristics of individuals (i.e., users) that are in proximity to the content delivery system (also referred to as a “scene”). As explained in detail hereinbelow, the profile may comprise information such as the number of individuals in the scene, and the gender, ages and ethnicity of the individuals. In some embodiments the profile may comprise behavior information such as engagement (i.e., is a given individual looking at presented content) and reaction (e.g., via facial expressions) to the presented content.

Once the profile is created, the profile can be updated to reflect any changes in the identified objects (e.g., one of the individuals carries a beverage can into the scene), the number of individuals in the scene, the characteristics of the individuals, and content that was selected and presented on a television. The profile can be used to select an assortment of content to be presented to the individuals via an on-screen menu, and the profile can be updated with content that was chosen from the menu and displayed on the television. The profile can also be updated with characteristics such as gaze directions and facial expressions of the individuals in the scene (i.e., in response to the presented content). For example, the profile can be updated with the number of individuals looking at the television and their facial expressions (e.g., smiling or frowning).

Utilizing a profile to select content recommendations can provide a “best guess” of content targeting interests of the individuals in the scene, thereby enhancing their viewing and interaction experience. Additionally, by analyzing the scene, embodiments of the present invention can custom tailor advertisements targeting demographics and preferences of the individuals in the scene.

### System Description

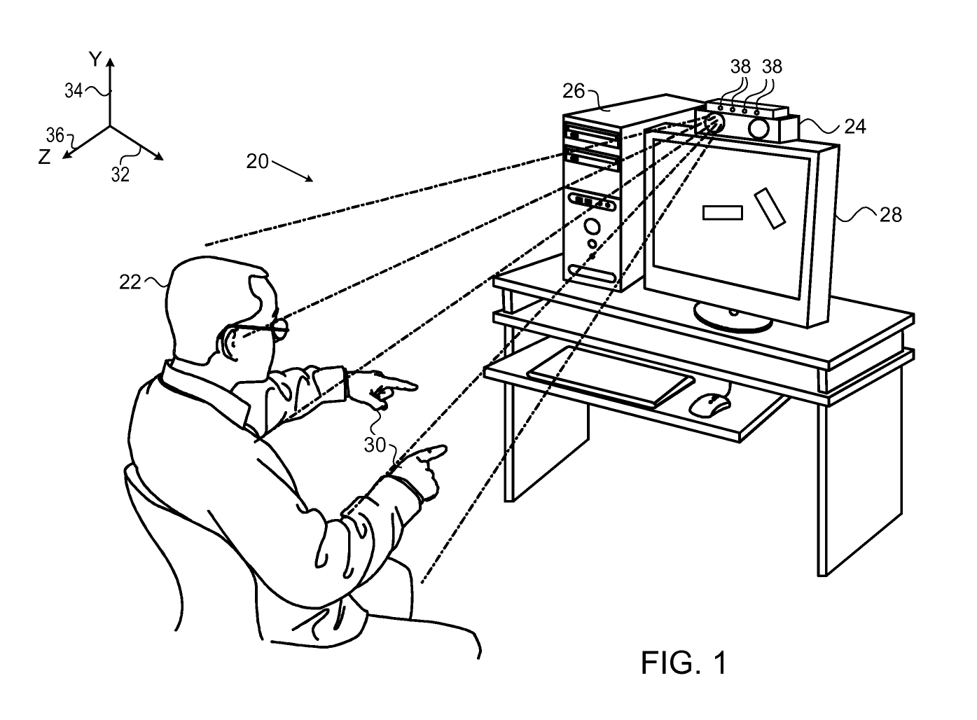

FIG. 1 is a schematic, pictorial illustration of a non-tactile 3D user interface 20 (also referred to herein as the 3D user interface) for operation by a user 22 of a computer 26, in accordance with an embodiment of the present invention. The non-tactile 3D user interface is based on a 3D sensing device 24 coupled to the computer, which captures 3D scene information of a scene that includes the body or at least a body part, such as a hand 30, of the user. Device 24 or a separate camera (not shown in the figures) may also capture video images of the scene. The information captured by device 24 is processed by computer 26, which drives a display 28 accordingly.

Computer 26, executing 3D user interface 20, processes data generated by device 24 in order to reconstruct a 3D map of user 22. The term “3D map” refers to a set of 3D coordinates measured, by way of example, with reference to a generally horizontal X-axis 32, a generally vertical Y-axis 34 and a depth Z-axis 36, based on device 24. The set of 3D coordinates can represent the surface of a given object, in this case the user's body.

In one embodiment, device 24 projects a pattern of spots onto the object and captures an image of the projected pattern. Computer 26 then computes the 3D coordinates of points on the surface of the user's body by triangulation, based on transverse shifts of the spots in the pattern. Methods and devices for this sort of triangulation-based 3D mapping using a projected pattern are described, for example, in PCT International Publications WO 2007/043036, WO 2007/105205 and WO 2008/120217, whose disclosures are incorporated herein by reference. Alternatively, interface 20 may use other methods of 3D mapping, using single or multiple cameras or other types of sensors, as are known in the art.

Computer 26 is configured to capture, via 3D sensing device 24, a sequence of depth maps over time. Each of the depth maps comprises a representation of a scene as a two-dimensional matrix of pixels, where each pixel corresponds to a respective location in the scene, and has a respective pixel depth value that is indicative of the distance from a certain reference location to the respective scene location. In other words, pixel values in the depth map indicate topographical information, rather than a brightness level and/or a color of any objects in the scene. For example, depth maps can be created by detecting and processing an image of an object onto which a laser speckle pattern is projected, as described in PCT International Publication WO 2007/043036 A1, whose disclosure is incorporated herein by reference.

In some embodiments, computer 26 can process the depth maps in order to segment and identify objects in the scene. Specifically, computer 26 can identify objects such as humanoid forms (i.e., 3D shapes whose structure resembles that of a human being) in a given depth map, and use changes in the identified objects (i.e., from scene to scene) as input for controlling computer applications.

For example, PCT International Publication WO 2007/132451, whose disclosure is incorporated herein by reference, describes a computer-implemented method where a given depth map is segmented in order to find a contour of a humanoid body. The contour can then be processed in order to identify a torso and one or more limbs of the body. An input can then be generated to control an application program running on a computer by analyzing a disposition of at least one of the identified limbs in the captured depth map.

In some embodiments, computer 26 can process captured depth maps in order to track a position of hand 30. By tracking the hand position, 3D user interface 20 can use hand 30 as a pointing device in order to control the computer or other devices such as a television and a set-top box. Additionally or alternatively, 3D user interface 20 may implement “digits input”, where user 22 uses hand 30 as a pointing device to select a digit presented on display 28. Tracking hand points and digits input are described in further detail in PCT International Publication WO IB2010/051055.

In additional embodiments, device 24 may include one or more audio sensors such as microphones 38. Computer 26 can be configured to receive, via microphones 38, audio input such as vocal commands from user 22. Microphones 38 can be arranged linearly (as shown here) to enable computer 26 to utilize beamforming techniques when processing vocal commands.

Computer 26 typically comprises a general-purpose computer processor, which is programmed in software to carry out the functions described hereinbelow. The software may be downloaded to the processor in electronic form, over a network, for example, or it may alternatively be provided on non-transitory tangible media, such as optical, magnetic, or electronic memory media. Alternatively or additionally, some or all of the functions of the image processor may be implemented in dedicated hardware, such as a custom or semi-custom integrated circuit or a programmable digital signal processor (DSP). Although computer 26 is shown in FIG. 1, by way of example, as a separate unit from sensing device 24, some or all of the processing functions of the computer may be performed by suitable dedicated circuitry within the housing of the sensing device or otherwise associated with the sensing device.

As another alternative, these processing functions may be carried out by a suitable processor that is integrated with display 28 (in a television set, for example) or with any other suitable sort of computerized device, such as a game console or media player. The sensing functions of device 24 may likewise be integrated into the computer or other computerized apparatus that is to be controlled by the sensor output.

### Profile Creation and Update

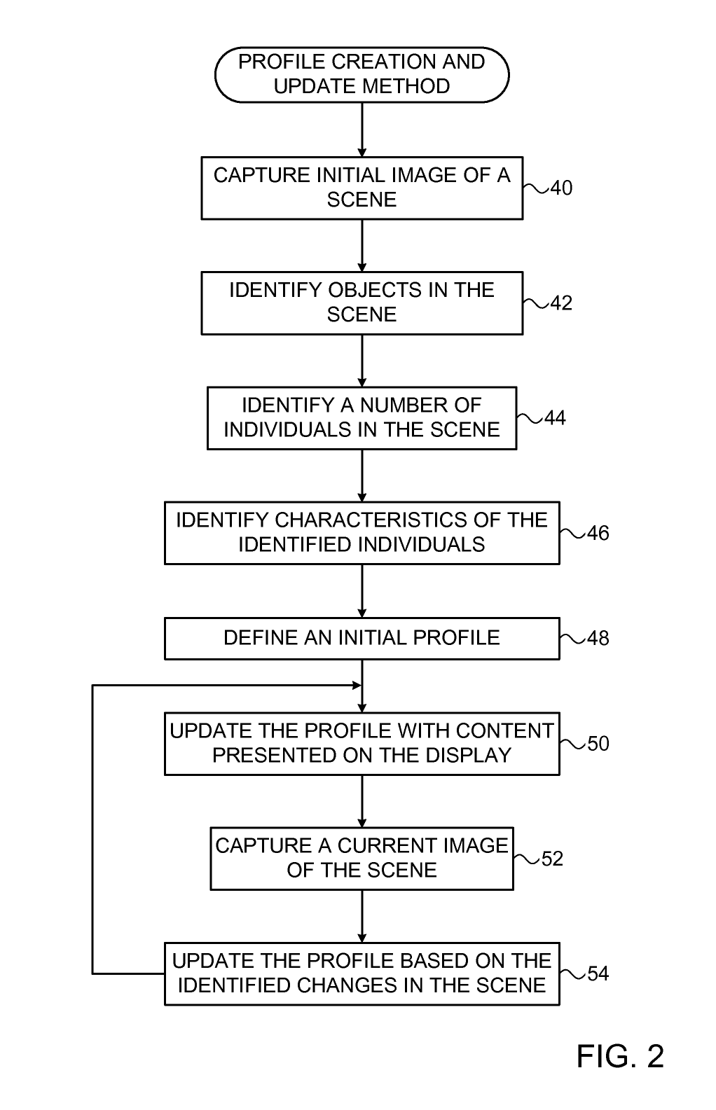

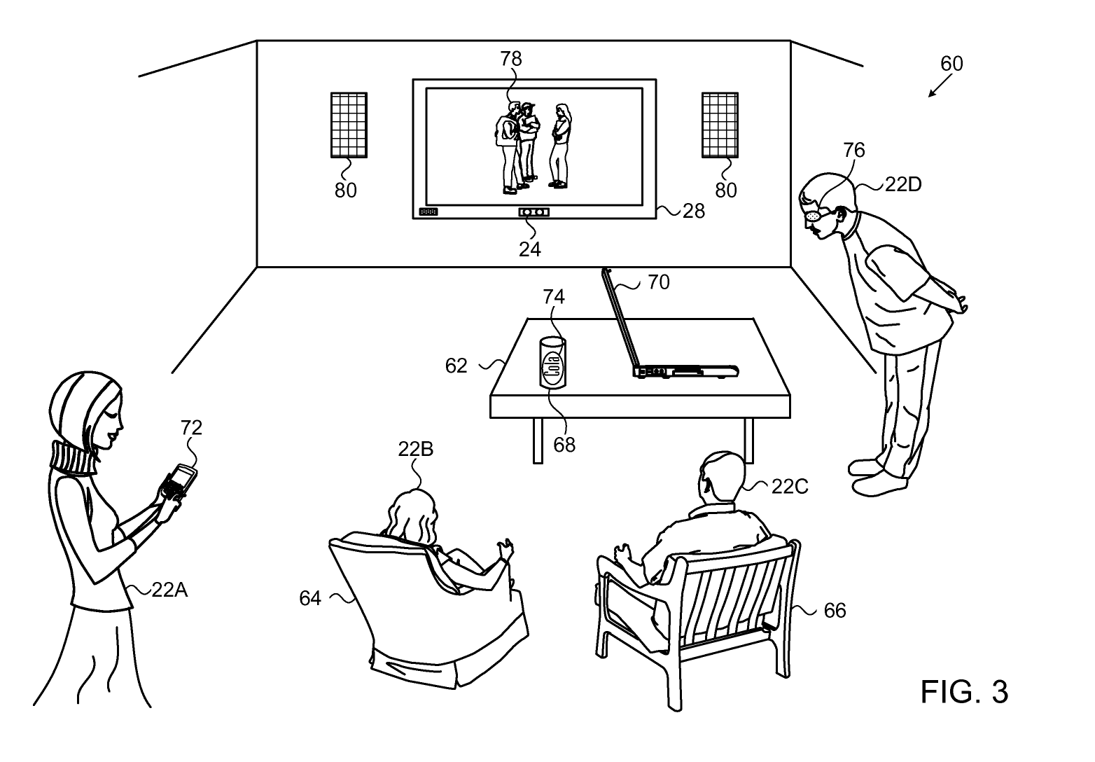

FIG. 2 is a flow diagram that schematically illustrates a method of creating and updating a scene profile, in accordance with an embodiment of the present invention, and FIG. 3 is a schematic pictorial illustration of a scene 60 analyzed by computer 26 when creating and updating the scene profile. As shown in FIG. 3, scene 60 comprises multiple users 22. In the description herein, users 22 may be differentiated by appending a letter to the identifying numeral, so that users 22 comprise a user 22A, a user 22B, a user 22C, and a user 22D.

In a first capture step 40, device 24 captures an initial image of scene 60, and computer 26 processes the initial image. To capture the initial image, computer 26 processes a signal received from sensing device 24. Images captured by device 24 and processed by computer 26 (including the initial image) may comprise either two dimensional (2D) images (typically color) of scene 60 or 3D depth maps of the scene.

In an object identification step 42, computer 26 identifies objects in the scene that are in proximity to the users. For example, computer 26 can identify furniture such as a table 62, and chairs 64 and 66. Additionally, computer 26 can identify miscellaneous objects in the room, such as a soda can 68, a portable computer 70 and a smartphone 72. When analyzing the objects in the scene computer 26 may identify brand logos, such as a logo 74 on soda can 68 (“COLA”) and a brand of portable computer 70 (brand not shown). Additionally, computer 26 can be configured to identify items worn by the users, such as eyeglasses 76.

In a first individual identification step 44, computer 26 identifies a number of users 22 present in proximity to display 28. For example, in the scene shown in FIG. 3, scene 60 comprises four individuals. Extracting information (e.g., objects and individuals) from three dimensional scenes (e.g., scene 60) is described in U.S. patent application Publication Ser. No. 12/854,187, filed Aug. 11, 2010, whose disclosure is incorporated herein by reference.

In a second individual identification step 46, computer 26 identifies characteristics of the individuals in scene 60. Examples of the characteristics computer 26 can identify typically comprise demographic characteristics and engagement characteristics. Examples of demographic characteristics include, but are not limited to:
A gender (i.e., male or female) of each user 22 in scene 60.
An estimated age of each user 22 in the scene. For example, computer 26 may be configured to group users 22 by broad age categories such as “child”, “teenager” and “adult”.
An ethnicity of each user 22. In some embodiments, computer 26 can analyze the captured image and identify visual features of the users that may indicate ethnicity. In some embodiments, computer 26 can identify a language spoken by a given user 22 by analyzing a motion of a given user's lips using “lip reading” techniques. Additionally or alternatively, sensing device 24 may include an audio sensor such as a microphone (not shown), and computer 26 can be configured to analyze an audio signal received from the audio sensor to identify a language spoken by any of the users.
Biometric information such as a height and a build of a given user 22.
A location of each user 22 in scene 60.

When analyzing scene 26, computer 26 may aggregate the demographic characteristics of the users in scene 60 to define a profile. For example, the scene shown in FIG. 3 comprises two adult males (users 22C and 22D) and two adult females (users 22A and 22B).

Examples of engagement characteristics computer 26 can identify include, but are not limited to:
Identifying a gaze direction of each user 22. As shown in FIG. 3, user 22A is gazing at smartphone 72, user 22D is gazing at computer 70, and users 22B and 22C are gazing at display 28. In an additional example (not shown), one of the users may be gazing at another user, or anywhere in scene 60. Alternatively, computer 26 may identify that a given user 22 has closed his/her eyes, thereby indicating that the given user may be asleep.
Identifying facial expressions (e.g., a smile or a grimace) of each user 22.

In a profile definition step 48, computer 26 defines an initial profile based on the identified objects, the number of identified users 22, and the identified characteristics of the users in scene 60. The profile may include other information such as a date and a time of day. Computer 26 can select a content 78, configurations of which are typically pre-stored in the computer, and present the selected content on display 28 responsively to the defined profile. Examples of selected content to be presented comprise a menu of recommended media choices (e.g., a menu of television shows, sporting events, movies or web sites), and one or more advertisements targeting the identified characteristics of the users in scene 60.

For example, if the defined profile indicates that the users comprise children, then computer 26 can select content 78 as an assortment of children's programming to present as on-screen menu choices. Alternatively, if the defined profile indicates that the defined profile indicates multiple adults (as shown in FIG. 3), then computer 26 can select content 78 as an assortment of movies or sporting events to present as on-screen menu choices.

In some embodiments, computer 26 can customize content based on the identified objects in scene 60. For example, computer 26 can identify items such as soda can 68 with logo 74, smartphone 72 and computer 70, and tailor content such as advertisements for users of those products. Additionally or alternatively, computer 26 can identify characteristics of the users in the scene. For example, computer 26 can present content targeting the ages, ethnicity and genders of the users. Computer 26 can also tailor content based on items the users are wearing, such as eyeglasses 76.

Additionally, if users 22 are interacting with a social web application presented on display 28, computer 26 can define a status based on the engagement characteristics of the users. For example the status may comprise the number of users gazing at the display, including age and gender information.

In a first update step 50, computer 26 identified content 78 presented on display 28, and updates the profile with the displayed content, so that the profile now includes the content. The content selected in step 50 typically comprises a part of the content initially presented on display 28 (i.e., in step 48). In embodiments of the present invention, examples of content include but are not limited to a menu of content (e.g., movies) choices presented by computer 26 or content selected by user 22 (e.g., via a menu) and presented on display 28. For example, computer 28 can initially present content 78 as a menu on display 28, and then update the profile with the part of the content chosen by user 22, such as a movie or a sporting event. Typically, the updated profile also includes characteristics of previous and current presented content (e.g., a sporting event). The updated profile enhances the capability of computer 26 to select content more appropriate to the users via an on-screen menu.

As described supra, computer 26 may be configured to identify the ethnicity of the users in scene 60. In some embodiments, computer 26 can present content 78 (e.g., targeted advertisements) based on the identified ethnicity. For example, if computer 26 identifies a language spoken by a given user 22, the computer can present content 78 in the identified language, or present the content with subtitles in the identified language.

In a second capture step 52, computer 26 receives a signal from sensing device 24 to capture a current image of scene 26, and in a second update step 54, computer 26 updates the profile with any identified changes in scene 60 (i.e., between the current image and a previously captured image). Upon updating the profile, computer 26 can update the content selected for presentation on display 28, and the method continues with step 50. The identified changes can be changes in the items in scene 60, or changes in the number and characteristics of the users (i.e., the characteristics described supra) in the scene.

In some embodiments, computer can adjust the content displayed on display 28 in response to the identified changes in scene 60. For example, computer 26 can implement a “boss key”, by darkening display 28 if the computer detects a new user entering the scene.

In additional embodiments, computer 26 can analyze a sequence of captured images to determine reactions of the users to the content presented on display 28. For example, the users' reactions may indicate an effectiveness of an advertisement presented on the display. The users' reactions can be measured by determining the gaze point of the users (i.e., were any of the users looking at the content?), and/or changes in facial expressions.

Profiles defined and updated using embodiments of the present invention may also be used by computer 26 to control beamforming parameters when receiving audio commands from a particular user 22 via microphones 38. In some embodiments, computer 26 can present content 78 on display 28, and using beamforming techniques that are known in the art, direct microphone beams (i.e., from the array of microphones 38) toward the particular user that is interacting with the 3D user interface (or multiple users that are interacting with the 3D user interface). By capturing a sequence of images of scene 60 and updating the profile, computer 26 can update parameters for the microphone beams as needed.

For example, if user 22B is interacting with the 3D user interface via vocal commands, and user 22B and 22C switch positions (i.e., user 22B sits in chair 66 and user 22C sits in chair 64), computer 26 can track user 22B, and direct the microphone beams to the new position of user 22B. Updating the microphone beam parameters can help filter out any ambient noise, thereby enabling computer 26 to process vocal commands from user 22B with greater accuracy.

When defining and updating the profile in the steps described in the flow diagram, computer 26 can analyze a combination of 2D and 3D images to identify characteristics of the users in scene 60. For example, computer 26 can analyze a 3D image to detect a given user's head, and then analyze 2D images to detect the demographic and engagement characteristics described supra. Once a given user is included in the profile, computer 26 can analyze 3D images to track the given user's position (i.e., a location and an orientation) in scene 60. Using 2D and 3D images to identify and track users is described in U.S. patent application Publication Ser. No. 13/036,022, filed Feb. 28, 2011, whose disclosure is incorporated herein by reference.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method, comprising:
capturing an image of a scene comprising one or more users in proximity to a display coupled to a computer executing a non-tactile interface;
processing the image to generate a profile of the one or more users; and
selecting content for presentation on the display responsively to the profile.

2. The method according to claim 1, and comprising:
presenting the content on the display;
identifying at least a part of the content in response to a choice by the one or more users; and
updating the profile with the identified content.

3. The method according to claim 1 and comprising:
identifying one or more objects in the scene; and
updating the profile with the one or more objects.

4. The method according to claim 1, and comprising capturing a current image of the scene, detecting any changes between the current image and a previously captured image, and updating the profile with the detected changes.

5. The method according to claim 1, and comprising identifying a number of users in the scene, identifying characteristics for each of the identified number of users, and updating the profile with the number of users and respective characteristics thereof.

6. The method according to claim 5, wherein the characteristics are selected from a list including a gender, an estimated age, a location, an ethnicity, biometric information, a gaze direction and a facial expression.

7. The method according to claim 6, and comprising capturing an audio signal from the scene, identifying a language spoken by one of the users in the scene, and identifying the ethnicity based on the detected language.

8. The method according to claim 6, and comprising capturing an audio signal from the scene, identifying the location of one or more of the users, and directing microphone beams towards the one or more of the users.

9. The method according to claim 6, and comprising utilizing the gaze direction and facial expression of the one or more users to measure a reaction to the presented content.

10. An apparatus, comprising:
a display; and
a computer executing a non-tactile interface and configured to capture an image of a scene comprising one or more users in proximity to the display, to process the image to generate a profile of the one or more users, and to select content for presentation on the display responsively to the profile.

11. The apparatus according to claim 10, wherein the computer is configured to present the content on the display, to identify at least a part of the content in response to a choice by the one or more users, and to update the profile with the identified content.

12. The apparatus according to claim 10, wherein the computer is configured to identify one or more objects in the scene, and to update the profile with the one or more objects.

13. The apparatus according to claim 10, wherein the computer is configured to capture a current image of the scene, detecting any changes between the current image and a previously captured image, and to update the profile with the detected changes.

14. The apparatus according to claim 10, wherein the computer is configured to identify a number of users in the scene, identifying characteristics for each of the identified number of users, and to update the profile with the number of users and respective characteristics thereof.

15. The apparatus according to claim 14, wherein the computer is configured to select the characteristics from a list including a gender, an estimated age, a location, an ethnicity, biometric information, a gaze direction and a facial expression.

16. The apparatus according to claim 15, wherein the computer is configured to capture an audio signal from the scene, to identify a language spoken by one of the users in the scene, and to identify the ethnicity based on the detected language.

17. The apparatus according to claim 15, wherein the computer is configured to capture an audio signal from the scene, to identify the location of one or more of the users, and to direct microphone beams towards the one or more of the users.

18. The apparatus according to claim 15, wherein the computer is configured to utilize the gaze direction and facial expression of the one or more users to measure a reaction to the presented content.

19. A computer software product comprising a non-transitory computer-readable medium, in which program instructions are stored, which instructions, when read by a computer executing a non-tactile user interface, cause the computer to capture an image of a scene comprising one or more users in proximity to the display, to process the image to generate a profile of the one or more users, and to select content for presentation on the display responsively to the profile.
